(19) United States
(12) Patent Application Publication
(10) Pub. No.: US 2013/0081369 A1
(43) Pub. Date: Apr. 4, 2013

(54) MULTIFUNCTIONAL CORN HARVESTER

(71) Applicant: Xue Jun Zhu, Tianjin (CN)

(72) Inventor: Xue Jun Zhu, Tianjin (CN)

(21) Appl. No.: 12/995,463

(22) PCT Filed: May 18, 2010
(86) PCT No.: PCT/CN10/72868

§ 371 Date: Dec. 1, 2010

(30) Foreign Application Priority Data
May 7, 2010 (CN) 201010165616.6

(51) Int. Cl. A01D 45/02

(52) U.S. Cl. CPC A01D 45/028
USPC 56/53

(57) ABSTRACT

The invention relates to a multifunctional corn harvester which comprises a vehicle, a longitudinal lift conveyer and a cutting platform. The longitudinal lift conveyer is installed on the vehicle with the cutting platform in front. The cutting platform is composed of an upper layer & a lower layer within a reel assembly device and a transverse corn conveying device as well on the upper. On the other hand, the lower layer cutting platform adopts a stalk collecting and conveying device, which comprises a root and stem cutter, a stalk conveying device, an auger and a stalk conveyor. This type ear corn harvester can realize not only the corn ear cutting but also diversified demands of stalk treatment. The compacted configuration adopts double-layer cutting platform combined with a corn ear picking function on the upper layer and stalk cutting & conveying functions on the lower layer. The alternative function is provided for stalk crushing device for cleaning & crushing. The machine utilizing a cutter type crusher can realize ensilage cutting function. When the plate at the bottom of the stalk conveying device is opened, the stalk laying function is plus as requested. Both ear and stem can be harvested accordingly by the machine with less grain discharging and diversified treatment of stalk simultaneously.

### REFERENCE TO PENDING APPLICATION

This application is a U.S. National Stage application filed under 35 U.S.C. §371, claiming priority under 35 U.S.C. §365 of International Application No. PCT/CN2010/072868, filed May 18, 2010 in the Chinese Patent Office.

### REFERENCE TO MICROFICHE APPENDIX

This application is not referenced in any microfiche appendix.

### BACKGROUND OF THE INVENTION

The invention belongs to agricultural machinery related to a corn harvester and particularly for multi function.

In order to solve the problem of air pollution caused by stalk burning and to develop animal husbandry as well, stalk cuttings are collected and returned to, or lay crop stalks on, the field without any smashing during corn ear harvesting process. Normally overseas corn plant is planted one season each year and stalks are returned to the field after corn harvesting then used for fertilizing fields in the winter fallow season. However, some crops, such as wheat and corn are harvested two times each year. With the development of industrial fuel, the stalks which act as main fuel in countryside especially have become waste due to burning in the fields. However, a large amount of feed is required for supporting the rapidly development animal husbandry. Therefore, to develop the harvester for ear and stem is an important significance.

The cutting platform of the corn harvester is one of the most important components which act as vital tasks for reeling, chopping, ear picking and conveying functions. It is fixedly installed on the vehicle and basically serves for the cutting platform.

The prior art corn harvesters can consolidate associated operation of ear picking-fruit cluster barking-silage together. However, this type of configuration cannot overcome the problems that shelled corns are mixed in stalk during the silage operation and the crushing device couldn't smash whole corn at the same time. Shelled corns are damaged due to stalk returning in the most of regions. The other shortage is that due to large dimension and poor adaptability to the country roads in rural area with so high price. So the design is different with other developed country from the application side.

In conclusion, the current technology of the corn harvester hasn't thoroughly solve the problem of corn harvesting and meet the requirement based on current agricultural conditions on application.

### SUMMARY OF THE INVENTION

The invention solves the technical problem of providing a component and a manufacturing process of the rare earth permanent magnet material.

The invention aims at providing a multifunctional corn harvester and overcoming the existing deficiencies with the scientific and reasonable cutting platform. The multifunctional corn harvester can harvest ear & stem as well, pick corn ear stably, treat to stalk diversification.

The purpose of the invention is to realize the technical scheme by the followings:

The multifunctional corn harvester, which is composed of a vehicle, a longitudinal lift conveyer and a cutting platform, is installed by cutting platform in front. The characteristic is with two layer cutting platform. The upper comprises a reel assembly device and a transverse corn conveying device which the sub-assembly of reel device is type of front fork head shape and connected with the input end of the transverse corn conveying device on the rear part of the reel sub-assembly. However, the output end of transverse corn conveying device is connected with the longitudinal lift conveyer. The lower layer platform is the device of stalk collecting & conveying combined by a cutter for root & stem, a stalk conveying device, a screw & stalk conveyor together. The root and stem cutter is fixed on the stalk conveying device in front. On the other hand, the screw conveyor is positioned on the rear end of the stalk conveying device and connected with the screw conveyor on the rear side.

On the other hand, the typical characteristics are installing a roller for removing the broken stem on the side of the transverse corn conveying device of the upper layer cutting platform.

Another characteristics for this corn harvester is that the reel sub-assembly in the upper layer is arranged double side reel devices and a protective plates are plus on each within stem pulling rollers or corn ear picking rollers which oppositely rotate are arranged in the reel device.

The installment of the cutter platform in front is set by hydraulic cylinders which the piston of the cylinder is connected with the stalk conveying device on the lower layer. The other hydraulic cylinders for control reel functions are installed on the reel device accordingly.

For the transverse corn conveying device, we adopt a belt or a chain structure according to claim 1 request.

Moreover, for the stalk conveying device, we adopt a belt or a chain creeper as well.

The advantages and beneficial effects of this invention will be:

1. The harvester can realize the function of corn ear picking & conveying function automatically. The broken corn mixed in corn stalk and the dropped shelled corn can be collected by the stalk smashing device to achieve the purposes of corn harvested to avoid smash which drop off & fall on the ground. Therefore, a real and effective corn harvester can be realized with advanced technology in the world.

2. The harvester can ensure the stalk smashing and collecting function for ensilage, stalk smashing and throwing to the fields and the whole stalk laying without being smashed which really realizes the diversified treatment to the stalk.

3. The harvester realizes the function not only ear harvesting but also the diversified treatment to the stalk. The integral structure adopts double-layer cutting platform within corn ear picking function on the upper and a stalk cutting & conveying function on the lower layer. The stalk crushing device is alternative for cleaning and crushing. A cutter type crusher can realize ensilage cutting and stalk laying function by opening the bottom plate.

The invention aims at providing a multifunctional corn harvester and overcoming the existing deficiencies with the scientific and reasonable cutting platform. The multifunctional corn harvester can harvest ear & stem as well, pick corn ear stably, treat to stalk diversification.

The purpose of the invention is to realize the technical scheme by the followings:

The multifunctional corn harvester, which is composed of a vehicle, a longitudinal lift conveyer and a cutting platform, is installed by cutting platform in front. The characteristic is with two layer cutting platform. The upper comprises a reel assembly device and a transverse corn conveying device which the sub-assembly of reel device is type of front fork head shape and connected with the input end of the transverse corn conveying device on the rear part of the reel sub-assembly. However, the output end of transverse corn conveying device is connected with the longitudinal lift conveyer. The lower layer platform is the device of stalk collecting & conveying combined by a cutter for root & stem, a stalk conveying device, a screw & stalk conveyor together. The root and stem cutter is fixed on the stalk conveying device in front. On the other hand, the screw conveyor is positioned on the rear end of the stalk conveying device and connected with the screw conveyor on the rear side.

On the other hand, the typical characteristics are installing a roller for removing the broken stem on the side of the transverse corn conveying device of the upper layer cutting platform.

Another characteristics for this corn harvester is that the reel sub-assembly in the upper layer is arranged double side reel devices and a protective plates are plus on each within stem pulling rollers or corn ear picking rollers which oppositely rotate are arranged in the reel device.

The installment of the cutter platform in front is set by hydraulic cylinders which the piston of the cylinder is connected with the stalk conveying device on the lower layer. The other hydraulic cylinders for control reel functions are installed on the reel device accordingly.

For the transverse corn conveying device, we adopt a belt or a chain structure according to claim 1 request.

Moreover, for the stalk conveying device, we adopt a belt or a chain creeper as well.

The advantages and beneficial effects of this invention will be:

The harvester can realize the function of corn ear picking & conveying function automatically. The broken corn mixed in corn stalk and the dropped shelled corn can be collected by the stalk smashing device to achieve the purposes of corn harvested to avoid smash which drop off & fall on the ground. Therefore, a real and effective corn harvester can be realized with advanced technology in the world.

The harvester can ensure the stalk smashing and collecting function for ensilage, stalk smashing and throwing to the fields and the whole stalk laying without being smashed which really realizes the diversified treatment to the stalk.

The harvester realizes the function not only ear harvesting but also the diversified treatment to the stalk. The integral structure adopts double-layer cutting platform within corn ear picking function on the upper and a stalk cutting & conveying function on the lower layer. The stalk crushing device is alternative for cleaning and crushing. A cutter type crusher can realize ensilage cutting and stalk laying function by opening the bottom plate.

Upon reading the included description, other advantages and various alternative embodiments will become apparent to those skilled in the art. These embodiments are to be considered within the scope and spirit of the subject invention, which is only limited by the claims which follow and their equivalents.

### DESCRIPTION OF THE DRAWINGS

FIG. 1 is an overall structural principal view of the harvester;

FIG. 2 is a top view;

FIG. 3 is a structure diagram of the multifunctional harvester without the upper layer cutting platform, the longitudinal lift conveyer and the cab;

FIG. 4 is the structural principal view of the cutting platform of the multifunctional corn harvester;

FIG. 5 is the top view of FIG. 4;

FIG. 6 is the structural principal view of the upper layer cutting platform without the protective casing;

FIG. 7 is the top view of FIG. 6;

FIG. 8 is the three dimensional structural diagram of FIG. 6;

FIG. 9 is the schema of the stalk conveying device (belt) of the lower layer cutting platform;

FIG. 10 is a principal view of the transverse corn conveying device (belt) of the upper layer cutting platform;

FIG. 11 is a top view of FIG. 10.

### DETAILED DESCRIPTION OF THE INVENTION

The following detailed description shows the best currently contemplated modes of carrying out the invention. The description is not to be taken in a limiting sense, but is made for the purpose of illustrating the general principles of the invention and the best mode for practicing the invention, since the scope of the invention is best defined by the appended claims. The invention is capable of other embodiments and of being practiced or carried out in a variety of ways. It is to be understood that the phraseology and terminology employed herein are for the purpose of description and not of limitation.

Further detailed specification of the embodiment of the invention by combining the figures is as below; the embodiment is descriptive, not definitive, and cannot limit the protection range of the invention.

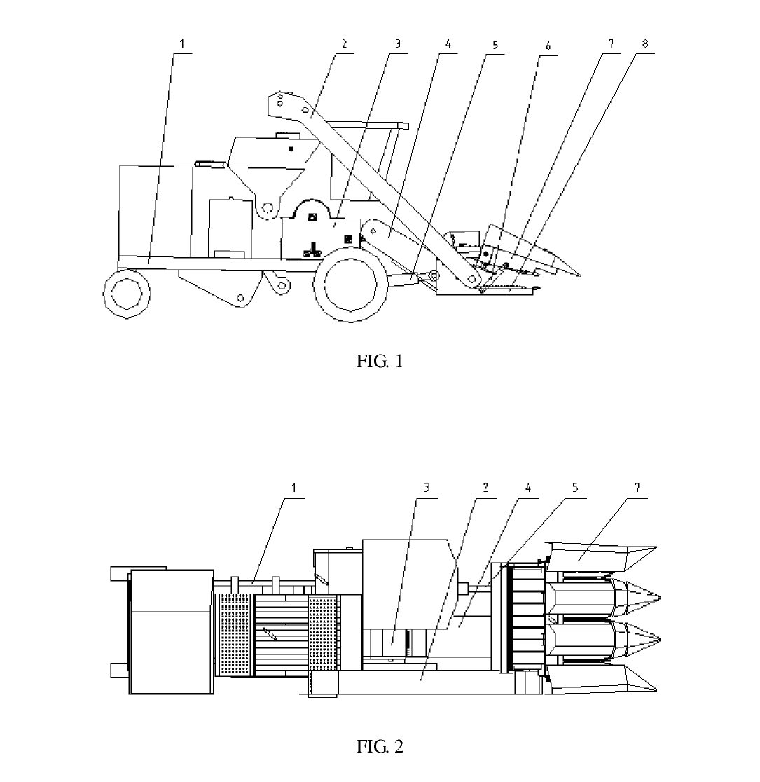

A multifunctional corn harvester (see FIGS. 1, 2 and 3) comprises a vehicle 1, a longitudinal lift conveyer 2 and a cutting platform; an engine assembly, a stalk cleaning and smashing device 3 (which belongs to the prior art) and the longitudinal lift conveyer (which belongs to the prior art) are installed on the vehicle; and the cutting platform is installed at the bottom end at the front part of the vehicle. The concrete installation method is hydraulic cylinders 5 are respectively installed at the bottom ends on two sides at the front part of the vehicle. The pistons of the cylinder are installed on the lower layer cutting platform to realize the angle swing and also adjust the cutting height of stem and root.

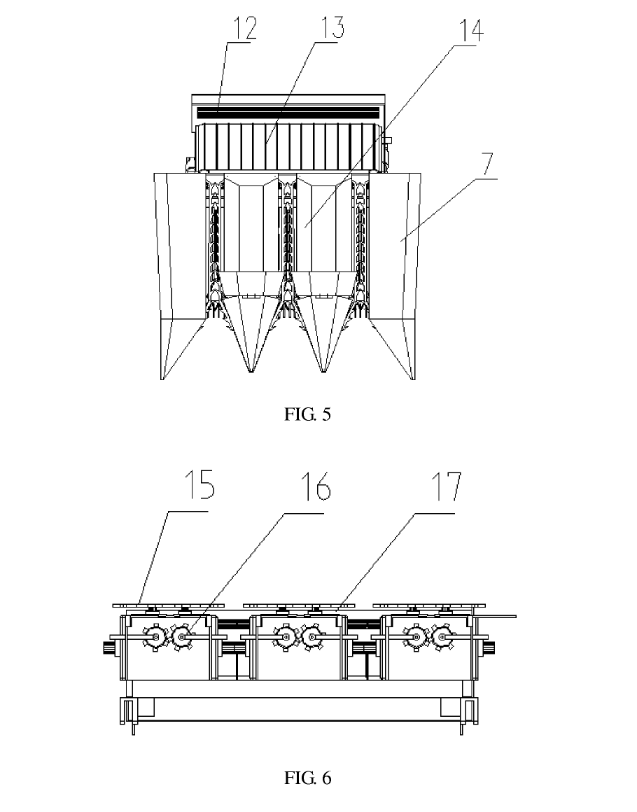

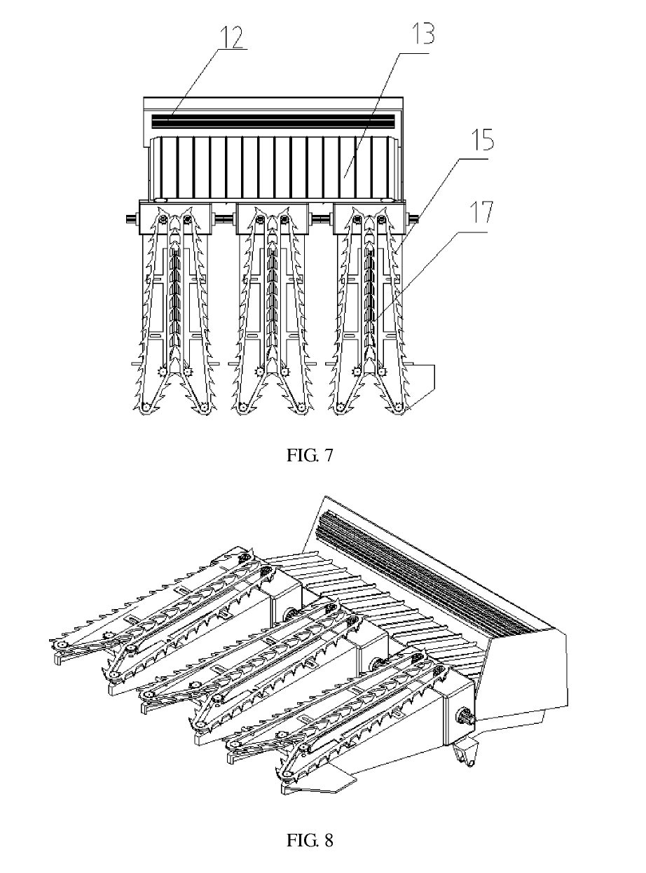

The cutting platform comprises the upper layer cutting platform and the lower layer cutting platform (see FIGS. 4 and 5) within lifting cylinders 6 are installed on the lower layer cutting platform. The pistons of the upper lifting cylinders are installed on the upper layer cutting platform to realize the angle swing control and adjustment of the upper layer cutting platform accordingly.

The concrete structures of the upper layer cutting platform and the lower layer cutting platform are as follows:

1. Upper Layer Cutting Platform

The upper layer cutting platform comprises a reel sub-assembly device 7 with a corn ear picking function and a transverse corn conveying device 13 arranged at the rear part of the reel device assembly; the reel device assembly comprises a plurality of reel devices 17 arranged side by side, the reel device is in a front fork head shape; a protective plate 14 is installed on each reel device; a reel sprocket 23 is installed at the front part of a divider; two stem pulling rollers 16 (ear picking rollers are also applicable, and the quantity of structural form of the rollers are more) are oppositely installed in the divider; the lower end of the longitudinal lift conveyer is connected with one end of the transverse corn conveying device; the transverse corn conveying device can adopt a chain row type conveyor belt and can also adopt belt 19 shown in FIGS. 10 and 11; a broken stem removing roller 12 is installed on one side of the transverse corn conveying device, which has the effect of preventing corn ear cut by the cutting platform from mixing broken stem stalk from entering the longitudinal lift conveyer, to remove broken stem mixed in the transversely conveyed corn ear under the effect of the two oppositely rotating broken stem removing roller.

2. Lower Layer Cutting Platform

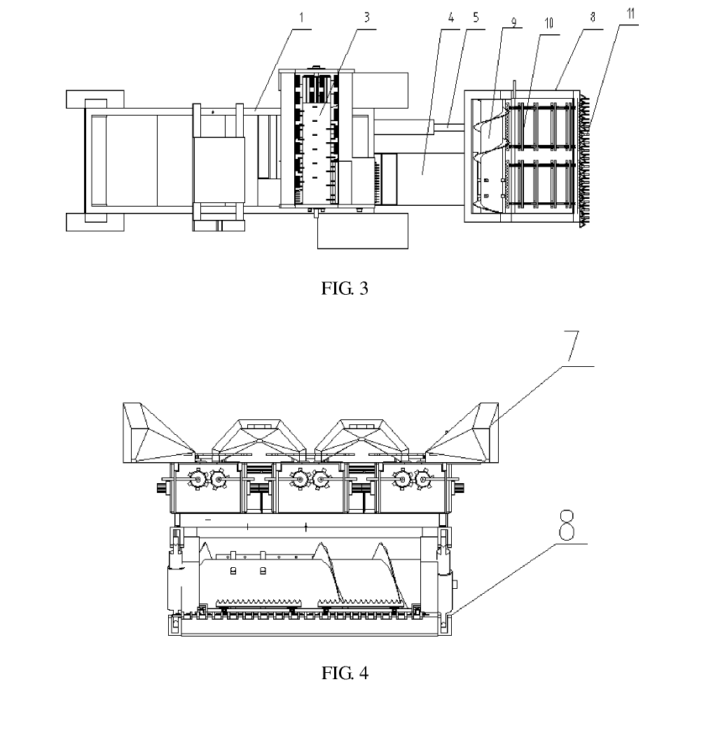

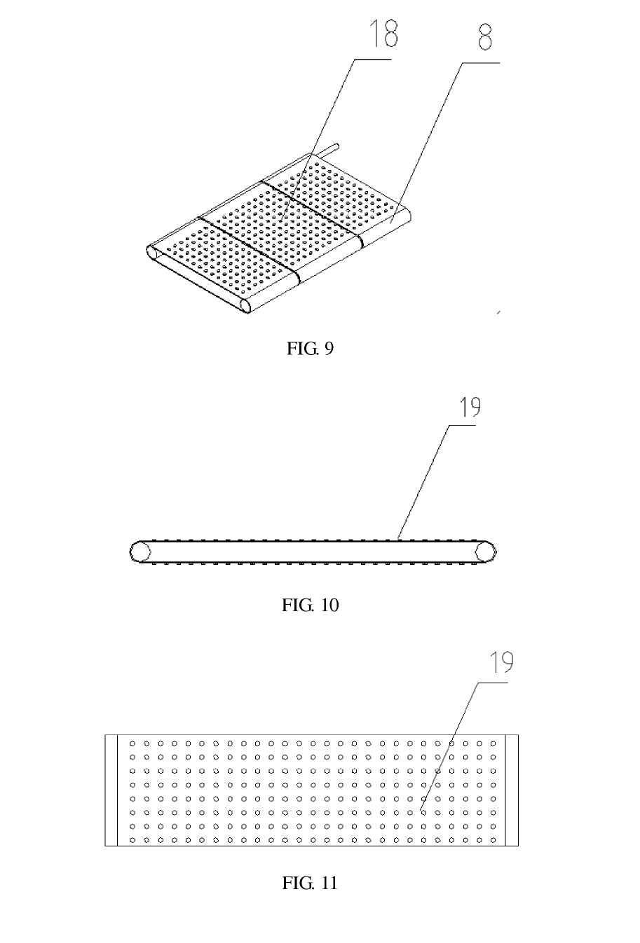

The lower layer cutting platform adopts a stalk collecting and conveying device 8, which is positioned below the reel device and collects stalk smashed by the reel device (see FIG. 3), and comprises a root and stem cutter 11, a stalk conveying device 10, a screw conveyor 9 and a stalk conveyor 4; the root and stem cutter is fixedly installed at the front end of the stalk conveying device; the stalk conveying device can adopts a chain creeper type conveyor belt or a belt 18 shown in FIG. 9; the screw conveyor is positioned at the rear end of the stalk conveying device; and the rear end of the screw conveyor is connected with the stalk conveying device. A stalk collecting and adjusting device collects the stalk smashed by the reel device; the smashed stalk enters the stalk conveyer through the stalk conveying device and the screw conveyor and then enters an auxiliary smashing device fixedly installed on the vehicle to be further smashed; and then the smashed stalk is collected or thrown to the fields.

A movable bottom plate (see FIG. 1, not marked) can be installed at the lower bottom surface of the screw conveyor, namely the lower laying function can be realized by opening the bottom plate.

The parts, which are not introduced in detail, of the invention are the prior art.

The invention adopts the operational principle as follows:

Whole corn is led into the fork-shaped inlet of the reel device assembly from a reel sprocket under the effects of reel devices; stalk cutting is accomplished in the inlet; and the cut stalk enters the stalk conveyer through the stalk conveying belt and the screw conveyor.

The corn ear and the stalk of the whole corn are separated on the reel device; the corn ear is fed to the transverse corn conveying device under the effects of the reel sprocket and the protective plate; and corn is collected and conveyed to the lower end of the longitudinal lift conveyer through the transverse corn conveying device.

The separated stalk on the reel devices, unpicked corn ear and dropped falling shelled corn drop into the stalk conveying device and are fed into the screw conveyer, and then fed into the auxiliary smashing device through the stalk conveyer to be collected.

While embodiments of the present invention have been illustrated and described, such disclosures should not be regarded as any limitation of the scope of our invention. The true scope of our invention is defined in the appended claims. Therefore, it is intended that the appended claims shall be construed to include both the preferred embodiment and all such variations and modifications as fall within the spirit and scope of the invention.

We claim:

1. A multifunctional corn harvester comprising:
a vehicle;
a longitudinal lift conveyer and a cutting platform, said cutting platform having an upper layer platform and a lower layer platform,
said upper layer platform having a reel assembly device and a transverse corn conveying device, said reel device has a front fork head shape and connected with the input end of said transverse corn conveying device, said input end being located at the back portion of said reel assembly device, the output end of said transverse corn conveying device connected with the longitudinal lift conveyer; and
said lower layer platform has a cutter, a stalk conveying device and an auger and stalk conveyor, said root and stem cutter being fixed on the front of said stalk conveying device, said auger conveyor positioned on the back end of said stalk conveying device and connected with the back side of said auger conveyor.

2. The multifunctional corn harvester of claim 1 further comprising: a roller on the side of the transverse corn conveying device of the upper layer cutting platform.

3. The multifunctional corn harvester of claim 1, further comprising double side reel devices and one or more protective plates.

4. The multifunctional corn harvester of claim 1 wherein the installment of the cutter platform is set by installed on the bottom of the front of the vehicle hydraulic cylinders which the piston of the cylinder is connected with the stalk conveying device on the lower layer.

5. The multifunctional corn harvester of claim 1, wherein said transverse corn conveying device has a belt or a chain structure.

6. The multifunctional corn harvester of claim 1, wherein said stalk conveying device has a belt or a chain creeper.
